(19) United States
(12) Patent Application Publication
(10) Pub. No.: US 2022/0308015 A1
(43) Pub. Date: Sep. 29, 2022

(54) MEMBRANE INSPECTION METHOD BASED ON MAGNETIC FIELD SENSING

(71) Applicants: Solmax International Inc., Vercheres, Quebec (CA); SB TECHNOLOGIES INC., Sherbrooke, Quebec (CA)

(72) Inventors: David Roy-Guay, Sherbrooke, Quebec (CA); Zackary Flansberry, Sherbrooke, Quebec (CA); Vincent Philippe Guillette, Vercheres (CA)

(21) Appl. No.: 17/619,512

(22) PCT Filed: Jun. 26, 2020
(86) PCT No.: PCT/CA2020/000080

§ 371 Date: Dec. 15, 2021

Related U.S. Application Data
(60) Provisional application No. 62/868,362, filed on Jun. 28, 2019.

(51) Int. Cl. G01N 27/82

(52) U.S. Cl. CPC G01N 27/82

(57) ABSTRACT

A method of detecting faults and ensuring integrity of membranes having magnetically functionalized particles, including moving a magnetometer over the membrane to measure at least one magnetic property, mapping the location of the measured properties, identifying anomalies among measured properties including the location of such anomalies, and repairing the membrane at the location where anomalies are identified.

### FIELD OF THE INVENTION

The present invention generally relates to the field of quality assurance of synthetic membranes.

### BACKGROUND OF THE INVENTION

Synthetic membranes, such as geomembranes and geosynthetics, are used around the globe in containment applications. They are commonly used to contain contaminants generated, for example, by the exploitation of mines, waste management, and petrochemistry. They may also be used to impound water, among many other applications.

Membrane integrity is key to environmental protection for multiple applications such as mining, waste management and aquaculture, to name a few, and during the installation of membranes over large areas, structural faults may occur due for a variety of reasons, including thermal constraints and the use of cutting tools. Validation of the membrane integrity is critical to conform to allowable leakage rates set by government agencies.

Following the initial installation of the membrane, its surface is easily accessible for integrity validation, such as the electrical leak location survey method by which holes of the size of a pinhole can be revealed and patched efficiently. However, in many applications, such as when solid materials are contained by a membrane, a layer of protective soil (e.g., sand or rocks) is added over the membrane which may cause movement and create weaknesses in a containment system (e.g., under environmental constraints). Moreover, the act of adding a layer of protective soil involves use of mechanical machinery on the membrane, which can cause wrinkles and other defects in the membrane prior to or during addition of the soil. Once buried, it is not possible to detect these faults visually. The same is true of membranes which retain fluids.

One technique which has been used with such inaccessible buried or covered membranes is to pair an electrically conductive membrane with a high voltage broom to detect pinhole sized holes. For example, heretofore in some installations, a 1 meter thick layer of sand (i.e., about 0.5-2.0 meter thick and preferably about 0.6-1 meter thick) has been added on top of the membrane to protect the membrane against hazardous objects and/or heavy machinery. However, earthwork operations to add, for example, sand can themselves lead to membrane ruptures or faults due to improper use of machinery, requiring that the membrane integrity be validated again (after sand is added) before delivery to the client. A method which has been used to validate the membrane integrity after it has been covered is ASTM 7007 which uses a dipole technique based on the closing of an electrical loop between the covered membrane, the hole to the membrane backing and an electrode connected outside of the surveyed area. This method can be used to detect leaks of at least one millimeter in diameter under approximately 1 meter of earthen material. However, the dipole technique requires on-site calibration of instruments and is dependent on environmental conditions, such as soil wetness or unfrozen soil. The test site must be electrically isolated, and the earthen cover material must present the proper environment and composition to be conductive. Hence, the soil must be humid, which renders the technique sensitive to environmental changes. Further, the operator must be trained, the equipment re-calibrated periodically and the high voltage equipment moved on a meter-by-meter step fashion over thousands of square meters.

The dipole inspection technique described above works for fault detection but field application of the technique faces adoption barriers due to very slow manual displacement of the equipment, low convenience of use and to environmental factors, such as rain, snow, frozen soil and wet/dry soil. These elements are burdensome to the adoption and deployment of membranes that prevent contaminants from leaking into the environment, particularly in the midst of growing legislation and decreasing allowable leakage rates and precision.

### SUMMARY OF THE INVENTION

The shortcomings of the prior art are generally mitigated by a new inspection method based on magnetic field sensing.

In one embodiment, a non-invasive method independent of environmental constraints and based on magnetism is detailed. A membrane composition is modified to incorporate metallic magnetic particles which modify Earth's magnetic field lines in a way that can be detected with a magnetometer. Magnetometers are systems used to determine the amplitude and orientation of a magnetic field and can be based on a variety of physical implementations. The membrane may be a single layer, or multiple layers (such as the membrane described in International Publication No. WO/2017/173548 A1), with the metallic magnetic particles incorporated in one or more of a multiple layer membrane.

The membrane can be fully magnetized to saturation or simply polarized via the enhanced magnetic susceptibility of the particles added to the membrane. Displacement or lack of overlapping membrane material generates a magnetic field anomaly from the membrane background signal. A magnetometer with sufficient sensitivity is scanned across the membrane area to map the anomaly profile. The dipole signature obtained leads directly to the fault location or the outlines in a gradiometry arrangement. For a centimeter diameter sized hole at a distance or depth of about 0.5 meter, the anomaly for an AlNiCo-doped membrane can reach a few nanoteslas (nT), an amplitude easily detectable by commercial magnetometers.

A vector magnetometer, such as the one disclosed by David Roy-Guay in the International Publication No. WO/2017173548, can be used to provide additional information about the shape, distance or volume of the fault. Individual field components are used to discriminate closely separated faults in a way that is not accessible by solely taking the magnetic field amplitude.

In another embodiment, the method of the present invention may be used to detect faults located on an exposed membrane or on a buried (or covered) membrane with a backfilling layer.

The magnetometer may also be arranged in an array providing correlations between the sensors which can be used to reduce noise and enhance positioning accuracy, spatial resolution and classification quality. The tensor gradiometry survey can also advantageously accelerate the survey speed and coverage of wide areas.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is an illustration of schematics of a magnetically functionalized geomembrane installed in a geotechnical site having a geomembrane fault under a filling material;

FIG. 2 is an illustration of different membrane magnetization techniques;

FIG. 3 is an illustration of the numerically simulated magnetic field components;

FIG. 4 is an illustration of the inspection method of the membrane with alternative vehicles of transport integrating one or multiple magnetometers; and

FIG. 5 is an illustration of experimental gradiometry data obtained according to the method herein and identifying a fault.

### DETAILED DESCRIPTION OF THE PREFERRED EMBODIMENT

A novel membrane inspection method based on magnetic field sensing is described hereinafter. Although the method is described in terms of specific illustrative embodiments, it is to be understood that the embodiments described herein are by way of example only and that the scope of the disclosed improvement is not intended to be limited thereby.

As used herein, “% (by weight)” refers to weight % as compared to the total weight percent of the phase or composition that is being discussed.

By “about”, “approximate” or “approximately”, it is meant that the value of % (by weight), time, pH or temperature can vary within a certain range depending on the margin of error of the method or device used to evaluate such % (by weight), time, pH or temperature. A margin of error of 10% is generally accepted.

For purposes of this application, the term “membrane” includes a liner, sheet, layer or any other material generally corresponding to a membrane, including particularly geomembranes, as would be understood by one of skill in the art.

A method of inspecting a membrane to detect leaks in the membrane is disclosed herein using magnetically sensitive devices, including magnetometers such as fluxgate magnetometers and atomic vapor magnetometers. Other devices which may be advantageously used in the method to detect aspects of the magnetic field include micro-electro-mechanical systems (MEMS) and devices for detecting magnetoresistance, superconducting quantum interference, Hall effect, and/or proton, magneto-optic or spin impurities in a crystal, which can perform as a scalar or vector magnetometer.

In accordance with at least one aspect of the disclosed method, leaks are detected in a barrier membrane covering an area, where magnetic particles are dispersed throughout the membrane. At least one of the devices is passed over the area to measure and map aspects of the magnetic field across the area where the membrane is laid down. Mapping may be accomplished by storing measured aspects of the magnetic field correlated with the location of the measurement, such as grid points on an X-Y grid system. Locations can be based, for example, on GPS coordinates with required accuracy, such as by Real Time Kinetics (RTK) (which can provide accuracy within a centimeter), with spacing between grid points related to magnetometer array spacing. A post may advantageously be placed in the ground adjacent the area to serve as a constant grid point at the same spot for subsequent inspections, measurements and repairs.

The area will have a generally uniform magnetic field resulting naturally from the Earth, and the magnetic particles in the membrane will generally uniformly affect that magnetic field. However, the magnetic particles will not be uniform at membrane anomalies (e.g., at faults where there are holes through the membrane, or there is a lack of any membrane) since the presence of magnetic particles will be different than the substantially uniform magnetic particles at the areas where the membrane is configured as desired. As a result, the magnetic field detected by the device will be anomalous (i.e., different than the otherwise substantially uniform magnetic field across the membrane). By mapping the location of such anomalies, the location of such faults, etc. may be identified and such locations may be used to direct repair efforts to the spot where repair is needed even though the membrane is covered and not visible.

That is, as disclosed herein, the integrity of a membrane may be verified by moving a suitable apparatus over an area to measure aspects of the magnetic field (such as amplitude and/or vector components) and recording that output to provide a geographical map correlating the apparatus anomalous readings to membrane faults, independent of soil conditions. (As used herein, unless otherwise stated, references to “over” an area with a membrane encompasses both on top of and beneath the membrane.) The apparatus may be moved across the area being investigated in any suitable manner, including manually and autonomously with a drone, robot, boat, or digging apparatus in a scanning fashion. The output may advantageously be collected and stored on suitable memory, including memory on the magnetometer and/or wired (e.g., USB or ethernet) or wireless (e.g., radio signal, WiFi, Bluetooth, or other wireless protocols) connection to a remote data storage memory (e.g., with a micro-controller or computer).

The detected magnetic signature may be used to validate the positioning, depth or weld pattern of the membrane as well as assess the depth and shape of a membrane fault in order to guide repair operations. The method may also be advantageously used to detect not only holes and/or welds in the membrane, but also wrinkles of the membrane, bumps, displacement, aging, cracks, pipe boots or any feature which can affect a magnetic field profile.

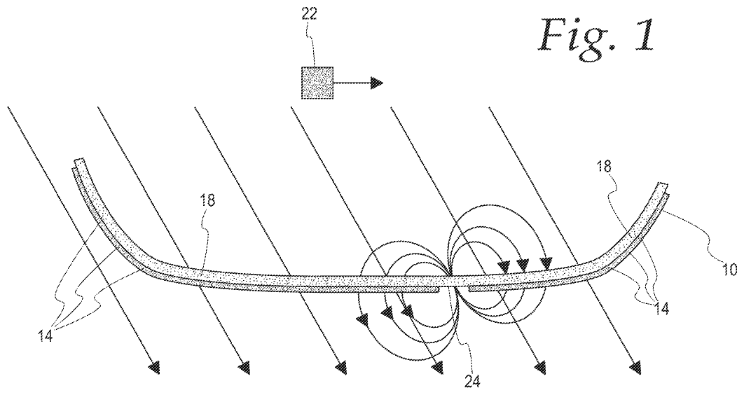

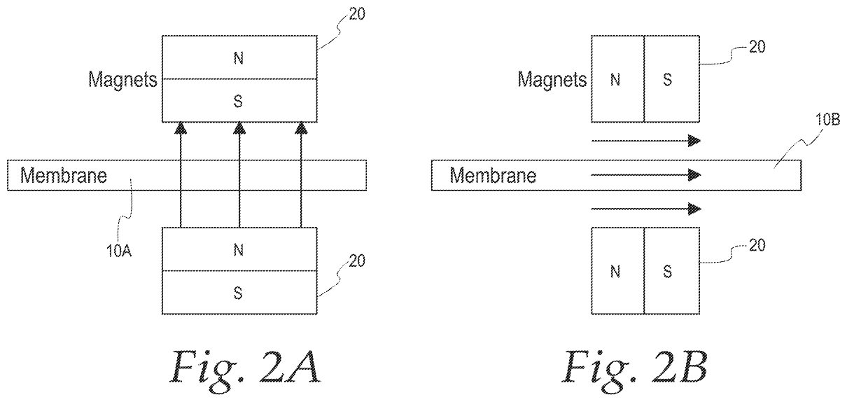

As illustrated in FIG. 1, a magnetically functionalized membrane 10 created by incorporating and polarizing metallic magnetic particles 14 is buried beneath fill material 18 (e.g., sand). The particles 14 may be polarized solely by the Earth's magnetic field, or may most advantageously be polarized during the membrane manufacturing process and before being installed in an area by passing the membrane 10 with metallic magnetic particles 14 close to a magnetizer apparatus 20 which incorporates strong magnets. As illustrated in FIGS. 2A-2B, the membrane 10 can be magnetized in plane, out of plane or with arbitrary magnetization with an appropriate permanent magnet configuration (or by the Earth's magnetic field as mentioned). FIG. 2A, for example, shows that the membrane 10A is polarized with magnetic lines perpendicular to the membrane plane, and FIG. 2B shows a polarized membrane with magnetic lines being parallel to (i.e., aligned with the plane of) the membrane 10B.

More specifically, the magnetically functionalized membrane 10 may advantageously be one or more layers of a polymeric material, with the polymeric material selected from synthetic polymers including, without limitation, polypropylene (PP), polyethylene (PE), and polyvinyl chloride (PVC), as would be understood by one of skill in the art. Moreover, PE may be selected, without limitation, from the group consisting of Linear Low Density PE (LLDPE), Low Density PE (LDPE), Medium Density PE (MDPE) and High Density PE (HDPE).

Magnetic particles may be included with at least one layer of the membrane 10 by, for example, mixing with polyethylene or other resin in a masterbatch before extruding, and/or spraying on the membrane 10, with the magnetic particles being disbursed and generally uniform throughout the membrane. The particles may be any suitable compound exhibiting magnetic properties, as well as mixtures thereof including, advantageously, Permalloy, AlNiCo, SmCo, Co, CoO, FeCoO, Neodymium, and/or Magnetite (Fe³O⁴), with the particles comprising about 1% to 30% by weight of the membrane layer in which the particles are incorporated. The amount of magnetic particles may be varied according to the thickness of the membrane layer, as well as the susceptibility of the particles to magnetization, where the amount should not degrade membrane integrity and should provide a sufficiently strong magnetic signal capable of being detected by the device used in the method.

With the magnetic particles therein, the membrane 10 may be advantageously magnetized by placing the membrane 10 near powerful magnets 20A, 20B in FIGS. 2A-2B) or, particularly with particles highly susceptible to magnetization, may be polarized by the Earth's magnetic field when installed in a geotechnical site.

The magnetic field contribution to Earth's magnetic field is modified by any structural deviation of the membrane 10 from a flat uniform configuration, including, for example, deviations or faults such as holes, rips and welds. A modulation, also known as a magnetic field anomaly, is created with magnetic field components specific to the structural fault or deviation. The magnetic field anomalies persist under sand, water and frozen soil, and are unaffected by typical temperature changes such as experienced on sites around the world.

A suitably sensitive device such as a magnetometer 22 (e.g., a vector or scalar single magnetometer or an array) is scanned in-plane or at different depths across the membrane area to detect any anomalous changes of magnetic field (e.g., a change of magnetic field vector components or amplitude). The necessary sensitivity will vary depending on such factors as the percent of magnetic particles incorporated, and the type of particles incorporated in the membrane 10. For example, a scalar magnetometer which measures the amplitude of the magnetic field could be used where the signal is large (such as 10 nT), where arrays of scalar magnetometers in a gradiometry pattern can enhance the signal to noise ratio. Vector magnetometers can also be used to provide data richness which can clearly identify faults, and multiple vector magnetometers can add another layer for fault classification and localization through tensor gradiometry.

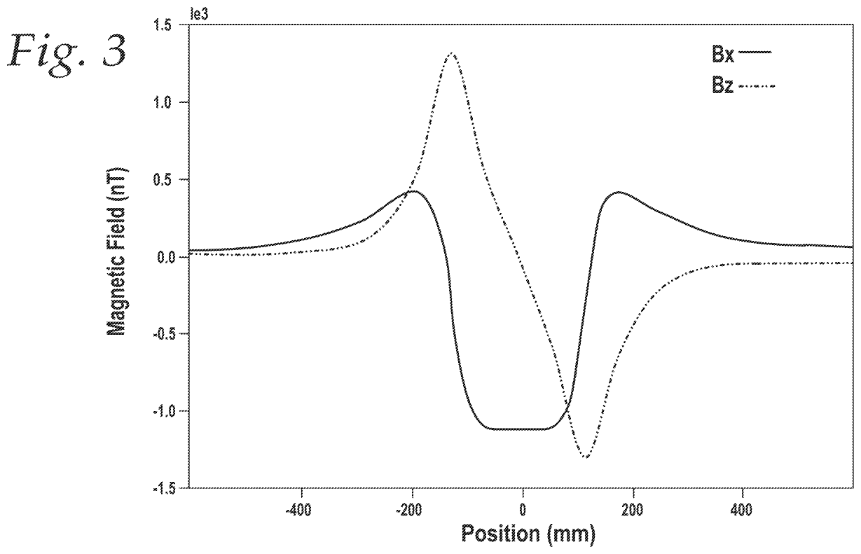

FIG. 3 illustrates the expected profile of simulated magnetic field components created by a hole (e.g., 24 in FIG. 1) of approximately 1 cm in diameter in a 1-mm thick doped membrane having approximately 1-30% (by weight) of FeCoO at a distance of 1 m for an out of plane magnetization of the membrane. It can be seen that a scalar or single magnetometer provides the central location of the hole, whereas multiple magnetometers can be used to efficiently reproduce not only the location of the fault, but the features of the fault. The magnetic field vector components (Bₓ, B_{z}) provided by a magnetometer arrangement or vector magnetometer can also be used to provide additional classification information, with the vector components used to enhance fault shape recognition through tensor gradiometry with multiple magnetometers and AI/ML algorithms that use the vectorial nature of the magnetic field. For example, the magnetic field amplitude or deviations from the dipole approximation can provide the area of the fault from which the anomaly arises. For faults with areas larger than the depth of the membrane, the shape can be reconstructed.

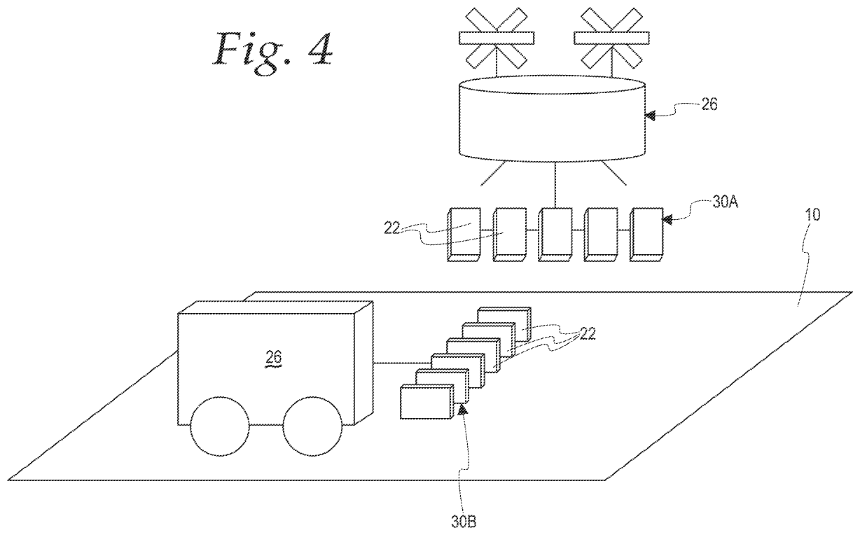

Suitable scanning systems including vehicles 26 carrying magnetometers 22 may be used to survey large sites. For example, a drone 26A and a cart 26B (which may be robot controlled or manually pushed) integrating one or multiple magnetometers are illustrated in FIG. 4. Such autonomous, guided or manual vehicles integrating one magnetometer or arrays 30A, 30B of magnetometers 22 to cover extended areas can be used for effective integrity validation by scanning the membrane surface. Generally, an on-ground scanning system is preferred due to rapidly decaying magnetic field (e.g., the magnetic field decreases by the cube of distance—1/distance³—such that the strength of the magnetic field is 1000 times stronger at a distance of 1 meter than it is at 10 meters). Nonetheless, in some settings the membrane composition can allow a larger sensor-to-membrane distance, such that the mapping can be done from the ground, in air, or underwater in a small underground autonomous vehicle such as a submarine. The vehicles 26 may advantageously have high vibrational stability, and a reduced or minimized magnetic signature and/or poles which support the magnetometers 22 spaced from the vehicle 26 to minimize interference by the vehicle 26. The vehicles 26 may also include additional components, such as a GPS system and storage for the GPS data and correlated measured aspects of the magnetic field.

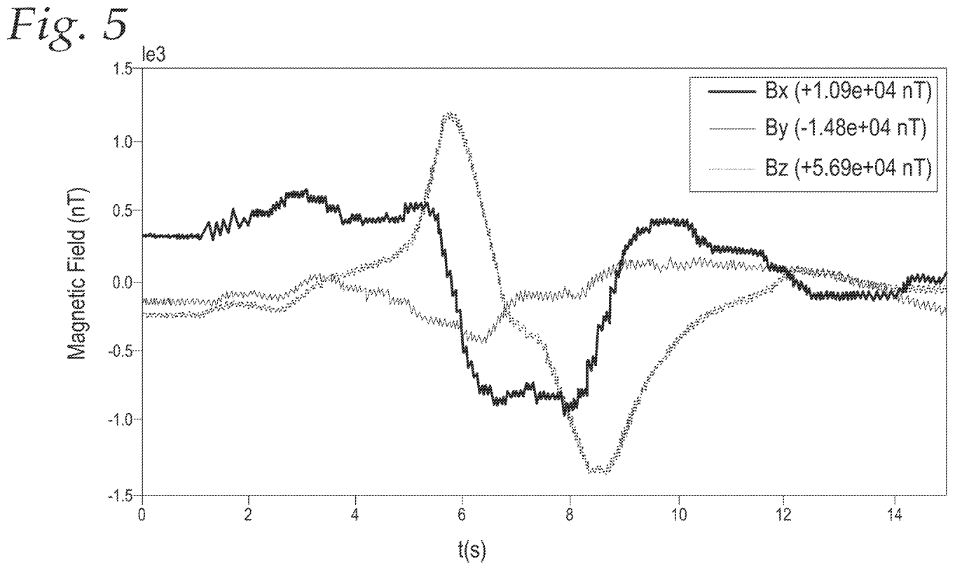

FIG. 5 is a sample line survey across a magnetically functionalized membrane with approximately 10% (by weight) of AlNiCo particles, wherein it can be seen that the vector magnetometer identified 20 cm×20 cm holes under 5 cm of wet sand. It should be appreciated that the wet sand on top of the membrane did not affect the measured magnetic signatures, confirming that integrity assessment can be accomplished without visual contact or particular soil compositions. The measured signal amplitudes are consistent with simulations done for a hole of 20 cm diameter in a 30 mils membrane core with 7 mils magnetic skin.

It should be appreciated that the method disclosed herein may be used to verify the integrity of a magnetized membrane irrespective of the magnetization method used. It should also be appreciated that the integrity validation of a membrane may be used with a variety of different types of magnetometers, magnetometer arrangements and/or vehicles, including but not limited to those described and/or illustrated herein. In some cases, a handheld, airplane, helicopter or manual vehicle and using low sensitivity magnetometers could also be used. Still further it should be appreciated that the present method may be used to verify the integrity of a polymeric sheet such as a geomembrane during the manufacturing process prior to placement at a geotechnical site.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A method of ensuring the integrity of a membrane, comprising the steps of:
measuring at least one magnetic property over the area of the membrane, wherein the membrane includes magnetized magnetic particles dispersed therein;
identifying locations where any of said measured magnetic properties is anomalous; and
repairing said membrane at said identified locations.

2. The method of claim 1, wherein said measuring step is performed over substantially the entire area of the membrane before said repairing step is performed, and further comprising the step of correlating each measured magnetic property with a map location of the membrane where the measurement was taken.

3. The method of claim 1, wherein said device is a magnetometer.

4. The method of claim 3, wherein said magnetometer is a vector magnetometer.

5. The method of claim 1, wherein said method steps are part of manufacturing said membrane prior to use.

6. The method of claim 1, wherein said membrane is a geomembrane and said steps of said method are performed while said geomembrane is installed at a geotechnical site and covered by fill material.

7. The method of claim 1, wherein said magnetic property is at least one of amplitude and vector components.

8. A method of identifying faults in a geomembrane, comprising the steps of:
moving a device over an area having a magnetized geomembrane with magnetic particles dispersed throughout said geomembrane, wherein said device measures at least one selected magnetic property;
mapping the measured magnetic property by correlating each measured magnetic property with the location of said geomembrane where said measured magnetic property was taken; and
identifying any location of said geomembrane where said measured selected magnetic property is anomalous to the measured selected magnetic property over most of said area.

9. The method of claim 8, further comprising the step of repairing said geomembrane at said mapped locations where said measured selected magnetic property is anomalous.

10. The method of claim 8, wherein said device is a magnetometer.

11. The method of claim 10, wherein said magnetometer is a vector magnetometer.

12. The method of claim 10, wherein said magnetometer is in an array.

13. The method of claim 8, wherein said device location is determined by Real Time Kinematic (RTK) GPS.

14. The method of claim 8, wherein said steps of said method are performed while said geomembrane is installed at a geotechnical site and covered by fill material.

15. The method of claim 8, wherein said magnetic property is at least one of amplitude and vector components.

16. A method of ensuring the integrity of a membrane, comprising the steps of:
measuring at least one magnetic property over the area of the membrane, wherein the membrane includes magnetized magnetic particles dispersed therein;
correlating each measured magnetic property with the location of the membrane where the measurement was taken;
identifying locations where any of said mapped magnetic properties is anomalous; and
repairing said membrane at said identified locations.

17. The method of claim 16, wherein said method steps are part of manufacturing said membrane prior to use.

18. The method of claim 16, wherein said membrane is a geomembrane and said steps of said method are performed while said geomembrane is installed at a geotechnical site covered by fill material.

19. The method of claim 16, wherein said magnetic property is at least one of amplitude and vector components.

20. A method of identifying faults in a membrane covered area, comprising the steps of:
covering the area with a magnetized membrane having magnetic particles dispersed therein;
mapping at least one magnetic property over the covered area; and
identifying map locations where said selected magnetic property is anomalous.

21. The method of claim 20, wherein said mapping step comprises
moving a magnetometer over said area to measure said magnetic property beneath said magnetometer;
identifying the location of the magnetometer as it moves over said area; and
recording the measured magnetic properties whereby the measured magnetic property is correlated with the location of the magnetometer as the time the magnetic property is measured.

22. The method of claim 20, wherein said membrane is magnetically functionalized.

23. The method of claim 20, wherein said membrane is a geomembrane and said steps of said method are performed while said geomembrane is installed at a geotechnical site and covered by fill material.

24. The method of claim 20, wherein said magnetic property is at least one of amplitude and vector components.
